(19) United States
(12) Patent Application Publication
(10) Pub. No.: US 2018/0052635 A1
(43) Pub. Date: Feb. 22, 2018

(54) ELECTRONIC CONTROL APPARATUS AND INFORMATION STORAGE METHOD FOR THE SAME

(71) Applicant: Mitsubishi Electric Corporation, Tokyo (JP)

(72) Inventor: Kyosuke OBARA, Tokyo (JP)

(73) Assignee: Mitsubishi Electric Corporation, Tokyo (JP)

(21) Appl. No.: 15/448,748

(22) Filed: Mar. 3, 2017

(30) Foreign Application Priority Data
Aug. 19, 2016 (JP) 2016-160969

(51) Int. Cl. G06F 3/06

(52) U.S. Cl. CPC G06F 3/0647; G06F 3/061; G06F 3/0604; G06F 3/0685; G06F 3/0619

(57) ABSTRACT

A non-volatile memory is provided with one or more storage groups in a storage region. The storage group is provided with one or more storage blocks. Each of the storage blocks includes an information storage segment, which stores control data to be used even after shutoff of power supply, a check data segment, which stores information indicating that the control data has been normally stored in the information storage segment, and a management information segment, which stores management information for determining whether the stored control data is old or new. The information storage segment is provided with one or more storage areas, each of which stores control data. The storage area is provided therein with one or more storage sections each having a data storage segment. The storage block is set as a unit of erasure, and the storage section is set as a unit of data writing.

### BACKGROUND OF THE INVENTION

### Field of the Invention

The present invention relates to an electronic control apparatus, which includes an electrically erasable non-volatile memory having a plurality of storage regions and a volatile memory, and to an information storage method for the electronic control apparatus.

### Description of the Related Art

In conventional automotive electronic control apparatuses, there are various pieces of stored information, such as control learning values and failure self-diagnosis results, which have to be retained even when the power supply of a vehicle is turned off, and, since these pieces of information are recorded on a volatile memory, power needs to be constantly supplied from a battery of the vehicle to the volatile memory so as to retain the content stored in the volatile memory even during shutoff of the power supply.

In response to this issue, owing to a request for a reduction in battery capacity in terms of, for example, vehicle weight reduction, lower power consumption during waiting after shutoff of the power supply has become required, so that such a method as to transfer and record stored information, which has already been recorded in a volatile memory at the time of shutoff of the power supply, to and on an electrically erasable non-volatile semiconductor memory (EEPROM) and to read out the stored information at the time of turning-on of the power supply to use the read-out information has become employed.

Furthermore, in the case of using an ordinary EEPROM, it is usually necessary to mount a semiconductor device different from a control microcomputer on a control board. However, storing the above-mentioned information in a part of a flash memory built in the microcomputer and used for storing control programs and control constants enables a reduction in cost and an improvement in reliability.

In recent years, for example, microcomputers having a plurality of built-in flash memories different in characteristics, such as a flash memory which is fast accessible and is specialized for storing control programs or control constants and a flash memory which is assured a great number of rewritable times and is premised on storing and updating control data, have become popular. However, in the case of a non-volatile semiconductor memory, such as a flash memory, the number of rewrite (erasure and storage) times for data is limited by a ceiling, and, if erasure and storage are repeated beyond the ceiling, normal operation is not guaranteed.

While, recently, the number of rewritable times of a flash memory has been significantly improved, depending on the frequency of update of control data to be stored, a shortage of the number of rewritable times is yet undeniable, and, if rewrite is repeated a predetermined number of times or more with respect to the same memory cell, erasure or storage would become unable to be normally performed after a certain point of time. If such situation occurs, since it becomes impossible to store valid information, it is necessary to limit the number of rewrite times with respect to the same memory cell as much as possible, and, even in a case where rewrite has been performed a predetermined number of times or more and, thus, it has become impossible to normally update information, such a situation that previously-stored information is completely lost has to be avoided.

As countermeasures against these issues, there is known an information storage method, such as that described in Patent Literature 1, which includes providing a plurality of storage regions on a memory, selecting a storage region based on the value of a control counter, and updating data in order. In this method, since update processing for data is performed in a time-division manner on the plurality of storage regions, it is possible to increase the number of update times as a whole while reducing the number of rewrite times with respect to a given storage region.

However, in the information storage method described in Patent Literature 1, since a control counter needs to be provided separately from the storage regions and, in a case where the value of the control counter has been broken due to some cause, readout of all of the data would become unable to be assured, there is a problem in terms of reliability of data retention.

As countermeasures against this problem, there is known a method, such as that described in Patent Literature 2, which includes providing a check data segment, which stores a computation result obtained by cyclic redundancy check capable of verifying the validity of information, and a counter, which is capable of relatively determining whether information in each storage region is old or new, in the corresponding storage region on a memory.

Moreover, usually, in the case of using a flash memory, there are limitations on specifications in that, for example, a range erasable by single processing is very broader than a writing range, re-writing is unable to be performed unless erasure is performed, and values obtained by reading areas in which erasure has been performed are different depending on types of flash memories.

If the information storage method described in Patent Literature 2 is utilized for a flash memory in which a range erasable by single processing is very broader than a unit of writing, a check data segment, a counter segment, and a control data segment need to be combined into one set, and two types of units of control, including a unit of data writing used for storing data and a unit of flash erasure used for erasing old data, need to be provided. In the present specification, the unit of data writing is referred to as a “storage section”, and the unit of flash erasure is referred to as a “storage block”. The storage block is configured to have a single storage section or a plurality of storage sections.

Furthermore, in a case where an erasing instruction is issued with respect to a storage block, since all of the information stored in the storage block is erased, if there is a need to retain the stored information even when unforeseen circumstances, such as shutoff of the power supply during the progress of storing information, occur, a plurality of storage blocks has to be used with respect to data to be stored. A unit of control obtained by combining a plurality of storage blocks used for storing the same control data into one set is referred to as a “storage group” in the present specification. However, if there is no need to retain the stored information even when unforeseen circumstances occur, a single storage block can be sufficient to be used.

If the inside of a flash memory is configured in the above-mentioned way, at least one storage group needs to be provided to store one type of control data, a single storage block or a plurality of storage blocks is arranged in one storage group, and a plurality of storage sections is arranged in one storage block.

According to the above-mentioned configuration, control data can be stored by the procedure of storing information in a storage section which has no information stored therein and is next to a storage section which has a maximum counter value each time a storing instruction for control data is issued, and, if there is no storage section which has no information stored therein inside a storage block in which the storage section which has a maximum counter value is arranged, after deleting old information stored in a next storage block inside the storage group, storing information in the leading storage section of the next storage block.

However, the resources of flash memories are limited, and a usual flash memory has only less than ten storage blocks arranged therein due to limitations of hardware. Accordingly, if one piece of control data is managed with a plurality of storage blocks, in the case of the above-mentioned information storage method, control data allowed to be stored in a flash memory would be limited to two or three types.

As a solution to this issue, there is a method of managing a plurality of pieces of control data with a single storage group. In the present specification, a region used for managing each control data arranged in the storage group is referred to as a “storage area”. When the inside of a flash memory is configured in consideration of storage areas, a plurality of storage blocks is arranged in a single storage group, a plurality of storage areas is arranged in a single storage block, and a plurality of storage sections is arranged in a single storage area.

However, in the above-mentioned configuration, if there has become no storage section which has no information stored therein in one storage area of a storage block, since there is a need to transfer information to a next storage block after erasing information stored in all of the storage areas of the next storage block, the latest control data that is managed with a different storage area is not allowed to be stored in the next storage block. Accordingly, the latest control data that is managed with all of the storage areas belonging to a storage group has to be stored in the same storage block.

To cause the latest control data that is managed with all of the storage areas to be stored in the same storage block, at the time of transferring to a next storage block after all of the storage sections in one storage area are used up, there is a need to copy the latest control data stored in all of the storage areas to the next storage block.

However, in a case where, due to an abnormality occurring in check data or counter in a storage section of a certain storage area, the latest stored data has become unable to be acquired from a storage block that is currently being used, control data that is managed with that storage area will have to be acquired from a valid storage section that is stored in another storage block. In that case, it follows that, with respect to only that storage area, the latest stored data is stored in another storage block. Accordingly, the above-mentioned control method has a problem in that, at the time of next issuing an instruction to store control data, a transfer destination for storage blocks may change depending on types of control data.

A solution to the above problem includes providing a storage block with a region in which to store management information, and implementing a logic for specifying the latest storage block. This enables implementing, for example, a procedure for causing the latest control data acquired from a storage area that does not belong to the latest storage block to be stored in a storage section which has no information stored therein in the latest storage block.

[Patent Literature 1] JP-A-11-144478

[Patent Literature 2] JP-A-2007-287022

As a logic for enabling determining whether a storage block is the latest one, there is a method of performing management by providing a counter segment in a management information segment of the storage block. This method includes providing a plurality of units of management each having a counter segment and a control data segment, as described in Patent Literature 1, and providing, with respect to the data segment, a plurality of units of management each having a counter segment, a control data segment, and a check data segment, as described in Patent Literature 2. In other words, in this method, the information storage method described in Patent Literature 1 is used for controlling storage blocks, and the information storage method described in Patent Literature 2 is used for controlling storage sections.

However, this method brings about the possibility that, as already mentioned in Patent Literature 2, in a case where some abnormality has occurred in a counter segment for controlling a storage block, stored control data may become unable to be acquired, and this method may not be used because there is also a flash memory having such a characteristic that the erased region is set to have indefinite values. Moreover, even if both control of storage blocks and control of storage sections are intended to be managed by the information storage method described in Patent Literature 2, since a value is stored in a storage block each time control data is updated, check data cannot be generated at the time of starting to use a storage block.

### SUMMARY OF THE INVENTION

The invention has been made in order to solve problems such as those described above, and has an object to provide an electronic control apparatus and an information storage method for the electronic control apparatus, which are capable of increasing the number of types of information to be stored and reducing the number of write times without being affected by specifications of non-volatile memories as much as possible.

An electronic control apparatus according the invention includes a non-volatile memory that is electrically erasable and a volatile memory, wherein the non-volatile memory is provided with one or more storage groups in a storage region, each of the storage groups is provided with one or more storage blocks, each of the storage blocks includes an information storage segment, which stores control data to be used even after shutoff of power supply, a check data segment, which stores information indicating that the control data has been normally stored in the information storage segment, and a management information segment, which stores management information containing information used for determining whether the stored control data is old or new, the information storage segment is provided with one or more storage areas, each of which is arranged to store control data to be stored in each of the storage blocks, each of the storage areas is provided therein with one or more storage sections each having a data storage segment, each of the storage blocks is set as a unit of erasure with which data erasure is able to be performed by a single operation, and each of the storage sections is set as a unit of data writing.

An information storage method for an electronic control apparatus according to the invention includes providing one or more storage blocks, in each of which data erasure is able to be performed by a single operation, in a storage region of a non-volatile memory capable of electrically erasing data, providing one or more storage areas, each of which is capable of storing control data, in each of the storage blocks, providing a management information segment, to which a region for storing management information for determining whether control data stored in each of the storage areas is old or new is allocated, in each of the storage blocks, and, in a case where control data stored in the non-volatile memory is to be read out or in a case where a need has arisen to store new control data in the non-volatile memory, specifying a storage block in which new control data is stored by referring to the management information, which is stored in the management information segment and used for determining the old or new control data.

Furthermore, an information storage method for an electronic control apparatus according to the invention includes providing one or more storage blocks, in each of which data erasure is able to be performed by a single operation, in a storage region of a non-volatile memory capable of electrically erasing data, providing one or more storage areas, each of which is capable of storing control data, in each of the storage blocks, providing, in each of the storage blocks, an information storage segment, which stores control data to be used even after shutoff of power supply, a check data segment, which stores information indicating that the control data has been normally stored in the information storage segment, a transfer initiation data segment, which stores information indicating that transfer of control data has been initiated when control data stored in a storage block is to be transferred to a storage block to be next used, a transfer completion data segment, which stores information indicating that storage of control data in the storage block to be next used has been completed, and a counter segment, which counts the number of times of transfer between the storage blocks, a step of, in a case where it is determined that a storage area in which to store new control data among the storage areas is insufficient in memory, storing predetermined information in the transfer initiation data segment of a transfer source storage block from among the storage blocks, a step of erasing control data stored in one storage block selected as a transfer destination storage block from among the storage blocks, a step of causing new control data to be stored in a storage area allocated to the transfer destination storage block, a step of causing a counter value acquired from the counter segment of the transfer source storage block, increased, and retained to be stored in the counter segment of the transfer destination storage block, a step of storing predetermined information in the check data segment of the transfer destination storage block, and a step of storing predetermined information in the transfer completion data segment of the transfer source storage block.

According to the invention, in dividing the storage region of a non-volatile memory, a unit of control serving as a storage block used at the time of erasing old data, a unit of control serving as a storage section used at the time of writing new data, and a unit of control serving as a storage area used to have a plurality of types of control data in a storage block can be provided, the number of types of storable control data, which would have been limited by limitations of a flash memory, can be significantly increased, and various pieces of data different in write timing can be stored in a non-volatile memory.

The foregoing and other objects, features, aspects, and advantages of the invention will be become apparent from the following detailed description of the embodiments when taken in conjunction with the accompanying drawings.

### BRIEF DESCRIPTION OF THE DRAWINGS

FIG. 1 is a configuration diagram illustrating an outline of an electronic control apparatus according to a first embodiment of the invention.

FIG. 2 is a diagram illustrating configurations of a storage region of a non-volatile memory and a storage region of a volatile memory (RAM) of the electronic control apparatus according to the first embodiment of the invention.

FIG. 3 is a configuration diagram illustrating an internal allocation of a storage group of the non-volatile memory of the electronic control apparatus according to the first embodiment of the invention.

FIG. 4 is a flowchart illustrating a latest information readout procedure in the electronic control apparatus according to the first embodiment of the invention.

FIG. 5 is a flowchart illustrating a latest storage block detection procedure in the non-volatile memory of the electronic control apparatus according to the first embodiment of the invention.

FIG. 6 is a flowchart illustrating an information transfer procedure in the electronic control apparatus according to the first embodiment of the invention.

### DETAILED DESCRIPTION OF THE EMBODIMENTS

### First Embodiment

Hereinafter, an electronic control apparatus and an information storage method for the same according to a first embodiment of the invention will be described with reference to the drawings. In the first embodiment, the invention is embodied as an inverter control ECU arranged to implement rotational speed control of a vehicle-mounted rotating machine, and, the configuration and function of the electronic control apparatus (ECU) are described in detail below.

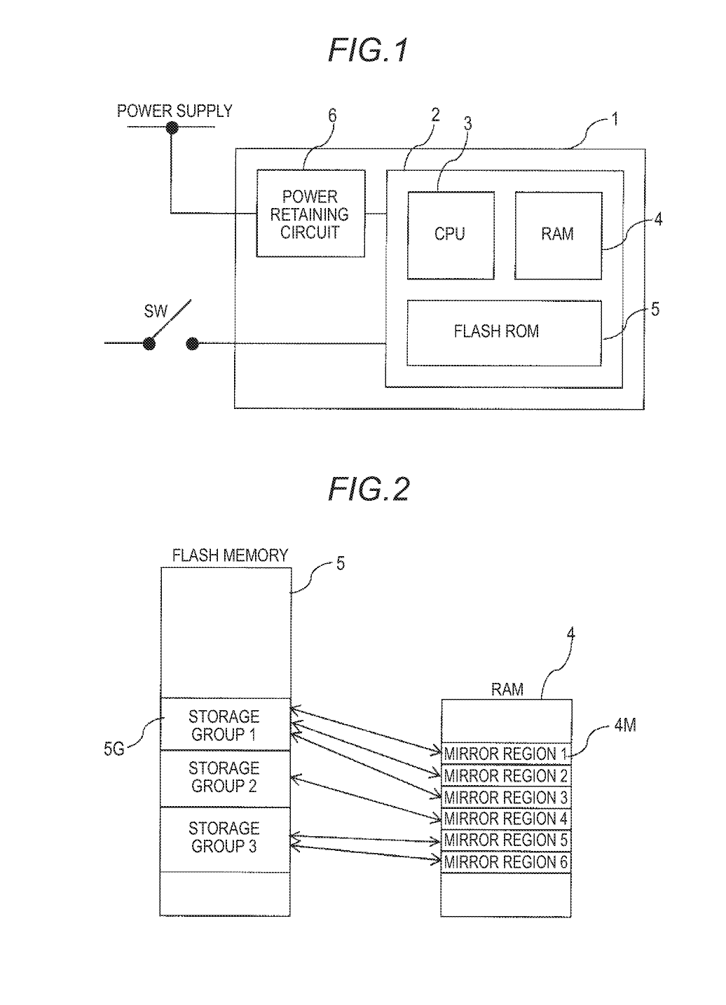

FIG. 1 is a diagram illustrating a schematic configuration of the electronic control apparatus (hereinafter referred to as an “ECU”). As illustrated in FIG. 1, the ECU 1 is provided with a microcomputer 2, and the microcomputer 2 contains a central processing unit (CPU) 3, a random access memory (RAM) 4, which is a volatile memory, and a flash memory 5, which is a non-volatile memory that is electrically erasable. The flash memory 5 stores a control program and control data, and a plurality of storage regions for storing control learning values and failure self-diagnosis results are allocated to a part of the flash memory 5. The CPU 3 controls the rotational speed of a rotating machine according to the control program stored in the flash memory 5. Moreover, the ECU 1 includes a power retaining circuit 6 and is thus capable of retaining power until the microcomputer 2 sends a shutoff instruction to the power retaining circuit 6 after the CPU 3 receives a power shutoff signal generated by a power switch SW.

Next, configurations of the flash memory 5 and the RAM 4 are described in detail with reference to FIG. 2. The flash memory 5 is divided into one or more storage groups 5G. These storage groups are referred to as, for example, storage groups 1, 2, and 3, as illustrated in FIG. 2, and these storage groups 1, 2, and 3 are arranged to store respective different pieces of information. Moreover, a plurality of mirror regions 4M is arranged in the RAM 4, and, in a case where, for example, mirror regions 1 to 6 are arranged in the RAM 4, respective different pieces of control data are stored in the mirror regions 1 to 6.

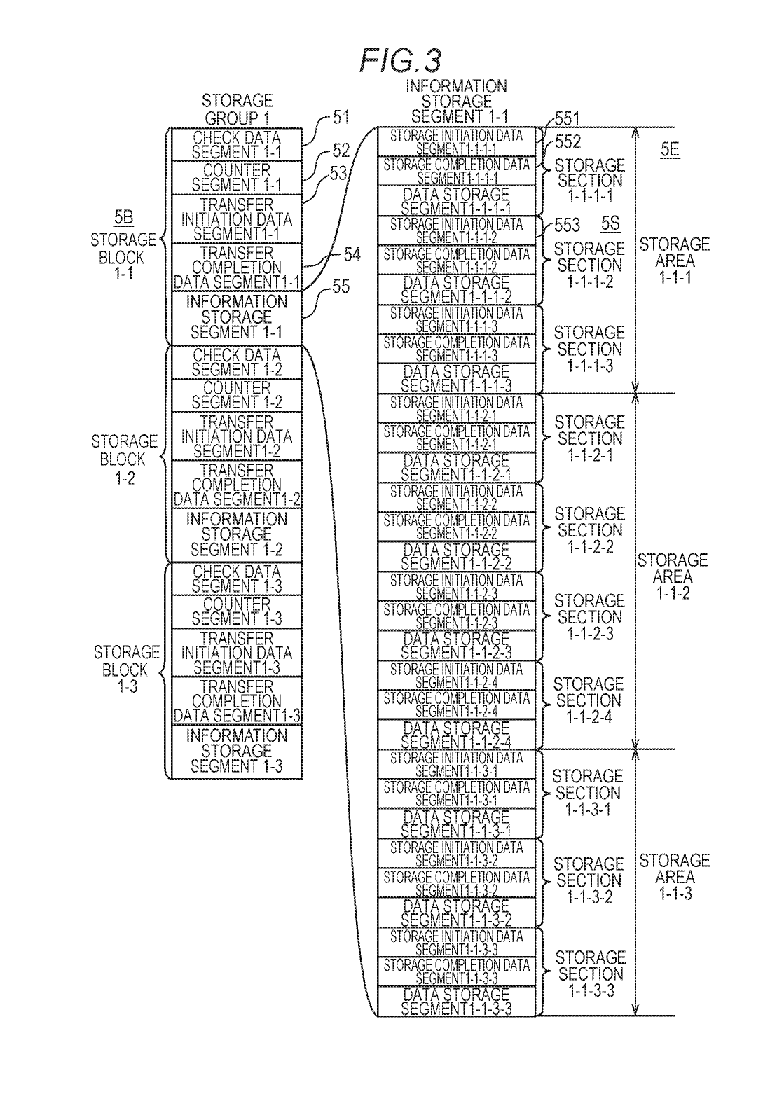

While the internal configuration of the flash memory 5 is described in detail with reference to FIG. 3, one or more storage blocks 5B are arranged in one storage group 5G, one or more storage areas 5E are arranged in one storage block 5B, and one or more storage sections 5S are arranged in one storage area 5E.

The size of each mirror region 4M is equal to that of one of data storage segments 553 that are managed with storage sections 5S in a storage area 5E which is arranged in a storage group 5G set in the flash memory 5 and which is used to manage control data corresponding to control data to be stored in each mirror region 4M.

To acquire information stored in the flash memory 5, the information is copied from a corresponding data storage segment 553 of the flash memory 5 to a mirror region 4M of the RAM 4. During the progress of control, a value stored in the mirror region 4M of the RAM 4 can be updated as appropriate. When a writing instruction to the flash memory 5 is issued at timing at which to intend to cause the flash memory 5 to store the information stored in the mirror region 4M of the RAM 4, the information stored in the RAM 4 is stored in a storage section 5S available for storage of a corresponding storage area 5E of a corresponding storage group 5G.

The internal configuration of a storage group 5G arranged in the flash memory 5 is described with reference to FIG. 3. Each storage group 5G is composed of one or more storage blocks 5B. One or more storage blocks 5B arranged in each storage group 5G are equal in configuration and size inside each storage group, and store information of the same type. Each storage block 5B is composed of a check data segment 51, a counter segment 52, a transfer initiation data segment 53, a transfer completion data segment 54, and an information storage segment 55. For example, in a case where the storage blocks 5B of the storage group 1 are composed of storage blocks 1-1, 1-2, and 1-3 as illustrated in FIG. 3, each storage block 5B includes the check data segment 51, the counter segment 52, the transfer initiation data segment 53, the transfer completion data segment 54, and the information storage segment 55, and the insides of the information storage segments of the respective storage blocks 5B are equal in configuration and size.

Here, the check data segment 51 of each storage block 5B is a region in which to store information indicating that control data has been normally written into the information storage segment 55 at the time of transfer between storage blocks, and this information is information that is last stored after control data is stored in the storage section 5S, and can be any information as long as it is information indicating that control data has been normally stored and can be, for example, a valid value (information merely indicative of “1” or “0”). The counter segment 52 is a region in which to store a counter value obtained by counting the number of times of transfer between storage blocks and used to relatively determine whether information stored in each region is old or new, and is used in a case where, due to power shutoff during data erasure or failure of a flash memory, the latest storage block has become unable to be specified only by transfer initiation data or transfer completion data. The transfer initiation data segment 53 is a region in which to store information indicating that transfer of data to a next region has been initiated, and the transfer completion data segment 54 is a region in which to store information indicating that transfer of data to a next region has been completed, in which such information can be any information as long as it is information indicating whether data has been stored and can be, for example, a valid value (information merely indicative of “1” or “0”). The transfer initiation data and the transfer completion data are used to specify the latest storage block. The information storage segment 55 is a region in which a plurality of storage areas 5E is arranged.

Furthermore, the counter segment 52, the transfer initiation data segment 53, and the transfer completion data segment 54 function as the region of a management information segment, which stores management data containing information for determining whether the stored control data is old or new.

Moreover, with regard to the counter segment 52, at the time of transfer between storage blocks, before information is stored in the check data segment 51 of a transfer destination storage block, a value stored in the counter segment 52 of a transfer source storage block is increased and is then stored in the counter segment 52 of the transfer destination storage block. Accordingly, in a case where, when it is determined whether a storage block is old or new, due to abnormalities of the transfer initiation data segment 53 and the transfer completion data segment 54, it has become impossible to determine whether the storage block is old or new, it is possible to determine whether information is old or new using the value stored in the counter segment 52 into which control data is assured by the check data segment 51 to have been normally written, and it is also possible to acquire the number of times of erasure in the flash memory 5.

A configuration example of the information storage segment 55 in a storage block is described with reference to FIG. 3. The information storage segment 55 is composed of one or more storage areas 5E. One or more storage sections 5S are arranged in each storage area 5E. Each storage section 5S is composed of a storage initiation data segment 551, a storage completion data segment 552, and a data storage segment 553.

Here, in the storage section 5S, the storage initiation data segment 551 is a region in which to store information indicating that storage of control data in the data storage segment 553 has been initialized, the storage completion data segment 552 is a region in which to store information indicating that storage of control data in the data storage segment 553 has been completed, and the data storage segment 553 is a region in which to store given control data. Information to be stored in the storage initiation data segment 551 and the storage completion data segment 552 can be any information as long as it is information indicating that control data has been normally stored (indicating that control data is valid) and can be, for example, a valid value (information merely indicative of “1” or “0”).

In FIG. 3, the information storage segment 55 of a storage block 1-1 is referred to as an “information storage segment 1-1”, a plurality of storage areas 1-1-1, 1-1-2, and 1-1-3 is arranged in the information storage segment 1-1, and a plurality of storage sections 1-1-1-1, 1-1-1-2, and 1-1-1-3 is arranged in the storage area 1-1-1.

Hereinafter, each region is referred to as “region name-(first number)-(second number)-(third number)-(fourth number)”. The first number denotes a storage group number, the second number denotes a storage block number, the third number denotes a storage area number, and the fourth number denotes a storage section number. For example, the third storage block from the head of the storage group 2 is referred to as a “storage block 2-3”, the first storage area of the storage block 2-3 is referred to as a “storage area 2-3-1”, the second storage section of the storage area 2-3-1 is referred to as a “storage section 2-3-1-2”, and a storage initiation data segment belonging to the storage section 2-3-1-2 is referred to as a “storage initiation data segment 2-3-1-2”.

The above-described configuration of the storage region of the flash memory 5 is summarized as follows.

(1) Storage Group 5G
A plurality of storage groups is arranged in the storage region.
A plurality of storage blocks 5B is arranged in each storage group.

(2) Storage Block 5B
All of the storage blocks arranged in the same storage group have the same configuration in, for example, the number of storage areas and the number of storage sections.
The capacity of each storage block is set to a multiple of a unit of flash erasure. Accordingly, one or more flash blocks are contained in each storage block.
Regions of a check data segment 51, a counter segment 52, a transfer initiation data segment 53, a transfer completion data segment 54, and an information storage segment 55 are arranged in each storage block.

(3) Storage Area 5E
A plurality of storage sections 5S is arranged in each storage area.

(4) Storage Section 5S
Each storage section is able to store a plurality of pieces of control data, and all of the pieces of control data are stored in a single storage section at the same timing. Such a plurality of pieces of control data is referred to as a “control data group”.
Pieces of control data of the same type are respectively stored in all of the plurality of storage sections arranged in the same storage area.
Regions of a storage initiation data segment 551, a storage completion data segment 552, and a data storage segment 553 are arranged in each storage section.

Furthermore, any segment described as being a plurality of segments in the above description can be changed to a single segment.

In the present embodiment, each storage section 5S serves as a unit of data writing, and each storage block 5B serves as a unit of flash erasure. A unit of control obtained by combining a plurality of storage blocks 5B used to store the same control data into one set is referred to as a “storage group”. A region used to manage each control data arranged in each storage group is referred to as a “storage area 5E”.

When the inside of the flash memory 5 is configured in consideration of storage areas 5E, a plurality of storage blocks 5B is arranged in each storage group 5G, a plurality of storage areas 5E is arranged in each storage block 5B, and a plurality of storage sections 5S is arranged in each storage area 5E.

The storage groups 5G are independent from each other, and, in a case where there is a plurality of storage groups, different pieces of control data are respectively stored in the storage groups 5G (even the same control data can be stored without any problem). The storage areas 5E respectively correspond to types included in a control data group to be managed in a storage group 5G, and are arranged in number equal to the number of types included in a control data group intended to be managed in the same storage group 5G.

Furthermore, hereinafter, information to be managed with a mirror region 1 of the RAM 4 and a storage area 1-1-1 of the flash memory 5 is referred to as control data A, information to be managed with a mirror region 2 of the RAM 4 and a storage area 1-1-2 of the flash memory 5 is referred to as control data B, and information to be managed with a mirror region 3 of the RAM 4 and a storage area 1-1-3 of the flash memory 5 is referred to as control data C. The control data A, the control data B, and the control data C serve as the respective names of types of control data.

Next, a procedure for acquiring control data that was last stored from a storage region for control data stored in the flash memory 5 configured as described above and copying the acquired control data to a mirror region of the RAM 4 is described in detail with reference to FIG. 2 to FIG. 5.

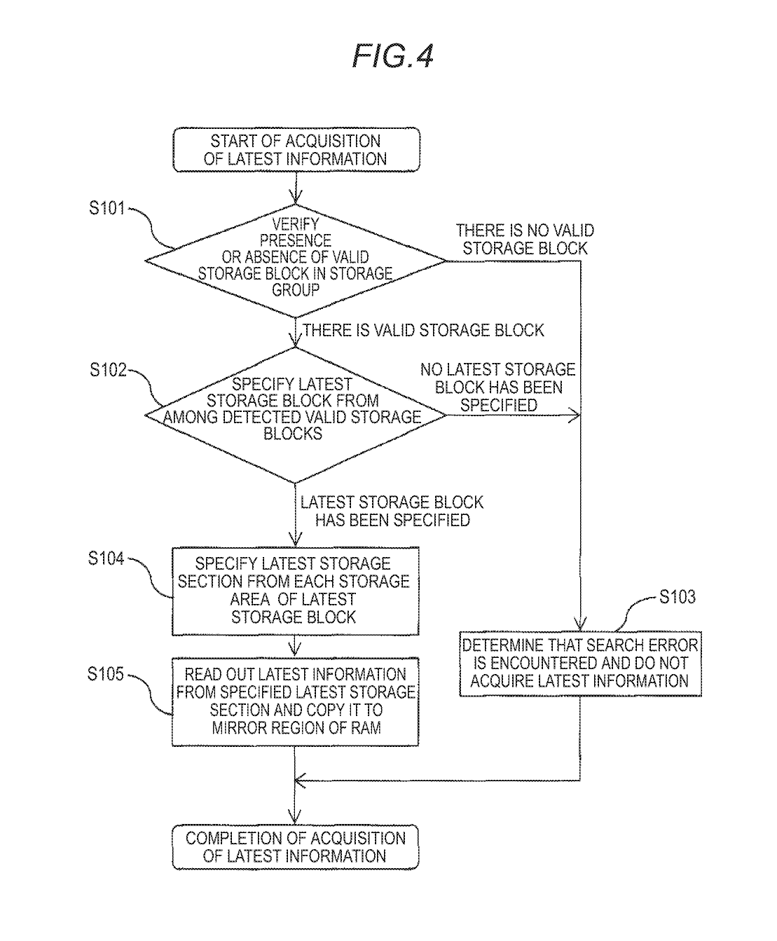

First, referring to FIG. 4, in processing S101, in order to select a valid storage block in which information is normally stored from among a plurality of storage blocks 5B arranged in one storage group 5G, the procedure checks whether a valid value (indicating that control data has been normally stored) is written in the check data segment 51 of each of all the storage blocks, and, if the valid value is written in the check data segment 51 of a storage block, determines that the storage block is a valid storage block. For example, in the case of selecting the latest data of control data A, the procedure checks the presence of a valid value in the respective check data segments 51 of the storage blocks 1-1, 1-2, and 1-3 included in the storage group 1, and selects a storage block in which the valid value is written.

Then, in processing S102, in a case where there is a plurality of valid storage blocks, in order to select the latest storage block, in which control data was last normally stored, from among the plurality of valid storage blocks, the procedure selects a valid storage block based on information stored in each of the transfer initiation data segments 53 and the transfer completion data segments 54 of all of the valid storage blocks. For example, in a case where the storage block 1-1 and the storage block 1-2 have been determined to be valid storage blocks, the procedure acquires values stored in the transfer initiation data segments 1-1 and 1-2 and the transfer completion data segments 1-1 and 1-2.

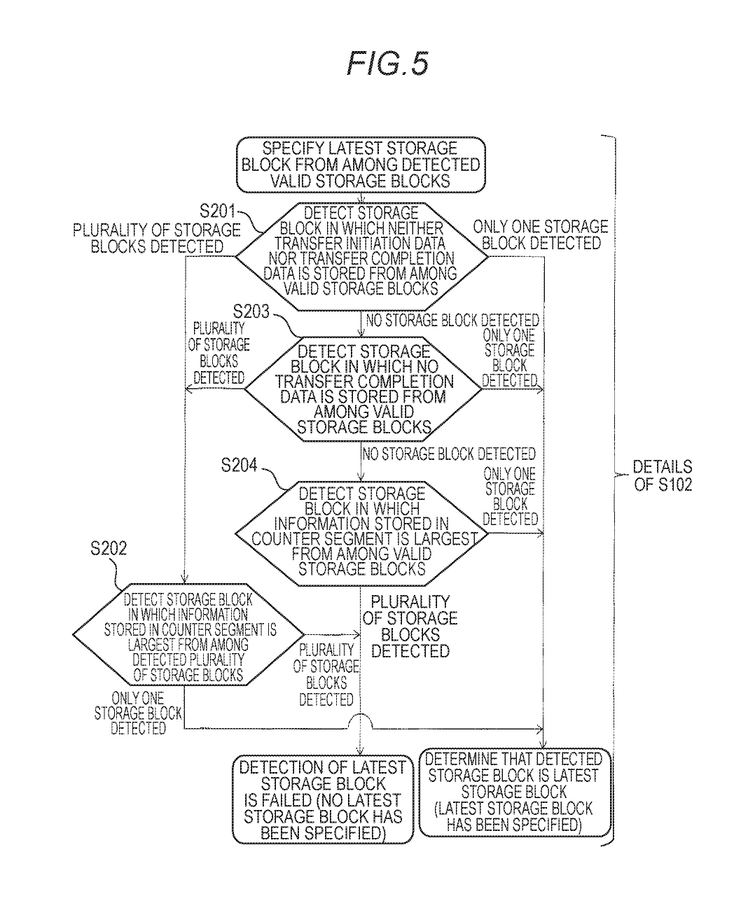

A detailed processing procedure in the above processing S102 is described with reference to FIG. 5. Referring to FIG. 5, in processing S201, in a case where there is only one storage block in which no information is stored in both the transfer initiation data segment 53 and the transfer completion data segment 54 (in an erased state), since the storage block in which no information is stored in both the transfer initiation data segment 53 and the transfer completion data segment 54 has not been subjected to transfer of the latest storage block from a transfer source storage block to a transfer destination storage block, the procedure determines that the storage block in which no information is stored in both the transfer initiation data segment 53 and the transfer completion data segment 54 is the latest storage block.

In processing S201, in a case where there is a plurality of storage blocks in which no information is stored in both the transfer initiation data segment 53 and the transfer completion data segment 54 (in an erased state), since it is impossible to specify the latest storage block only based on the transfer initiation data segment 53 and the transfer completion data segment 54, the procedure proceeds to processing S202. In processing S202, the procedure detects a storage block having the largest counter value by comparing the counter segments 52 of a plurality of storage blocks in which no information is stored in both the transfer initiation data segment 53 and the transfer completion data segment 54. In a case where there is only one storage block having the largest counter value, the procedure specifies the storage block having the largest counter value as the latest storage block, in which information was last normally stored. In processing S202, in a case where there is a plurality of storage blocks having the largest counter value, the procedure determines that detection of the latest storage block is failed, and then in processing S103, the procedure determines that a search error is encountered.

In processing S201, in a case where there is no storage block in which no information is stored in both the transfer initiation data segment 53 and the transfer completion data segment 54 (in an erased state), the procedure proceeds to step S203. For example, the occurrence of an accident, such as shutoff of the power supply, during transfer between storage blocks brings about this condition. In processing S203, the procedure detects, from among valid storage blocks in which information is normally stored, a storage block in which information is stored in the transfer initiation data segment 53 and no information is stored in the transfer completion data segment 54. In processing S203, in a case where there is only one storage block in which no information is stored in the transfer completion data segment 54, since some cause occurring during transfer of the latest storage block from a transfer source storage block to a transfer destination storage block at the time of the previous data storage has brought about a condition in which, as the data storage is interrupted before a valid value is stored in the check data segment 51 of the transfer destination storage block, the transfer source storage block is a storage block in which information is stored in the transfer initiation data segment 53 and no information is stored in the transfer completion data segment 54, the procedure determines that the storage block in which no information is stored in the transfer completion data segment 54 is the latest storage block.

In processing S203, in a case where there is no storage block in which no information is stored in both the transfer initiation data segment 53 and the transfer completion data segment 54 (in an erased state) and there is a plurality of storage blocks in which information is stored in the transfer initiation data segment 53 and no information is stored in the transfer completion data segment 54, since it is impossible to specify the latest storage block only based on the transfer initiation data segment 53 and the transfer completion data segment 54, the procedure proceeds to processing S202. In processing S202, the procedure detects a storage block having the largest counter value by comparing the counter segments 52 of a plurality of storage blocks in which information is stored in the transfer initiation data segment 53 and no information is stored in the transfer completion data segment 54, and, in a case where there is only one storage block having the largest counter value, the procedure specifies the storage block having the largest counter value as the latest storage block. In processing S202, in a case where there is a plurality of storage blocks having the largest counter value, the procedure determines that detection of the latest storage block is failed, and then in processing S103, the procedure determines that a search error is encountered.

In processing S203, in a case where there is no storage block in which no information is stored in the transfer completion data segment 54, the procedure proceeds to step S204. In processing S204, in a case where there is no storage block in which no management information is stored in both the transfer initiation data segment 53 and the transfer completion data segment 54 (in an erased state) and there is also no storage block in which management information is stored only in the transfer initiation data segment 53, since it is impossible to specify the latest storage block only based on the transfer initiation data segment 53 and the transfer completion data segment 54 as management data about a storage block which would normally be specified as the latest storage block has been corrupted due to some reason, the procedure compares the counter segments 52 of valid storage blocks. In processing S204, in a case where there is only one storage block having the largest counter value as a result of comparison of the counter segments 52 of valid storage blocks, the procedure specifies the storage block having the largest counter value as the latest storage block. In a case where there is a plurality of storage blocks having the largest counter value, the procedure determines that detection of the latest storage block is failed, and then in processing S103, the procedure determines that a search error is encountered.

Then, in processing S104 illustrated in FIG. 4, in order to specify the latest storage section, in which control data was last stored, from among each storage area 5E of the latest storage block, the procedure acquires valid values of the storage initiation data segment 551 and the storage completion data segment 552 of each storage section 5S in order from the bottom of the flash memory, and, in a case where valid values are stored in the storage initiation data segment 551 and the storage completion data segment 552, the procedure determines that a storage section 5S in which valid values are stored in the storage initiation data segment 551 and the storage completion data segment 552 is the latest storage section. For example, in a case where the latest control data of the control data A is searched for and the latest storage block is the storage block 1-1, if valid values are stored in the storage initiation data segment 1-1-1-3 and the storage completion data segment 1-1-1-3, the procedure determines that the storage section 1-1-1-3 is the latest storage section, and, if no valid value is stored in one of the storage initiation data segment 1-1-1-3 and the storage completion data segment 1-1-1-3 and valid values are stored in the storage initiation data segment 1-1-1-2 and the storage completion data segment 1-1-1-2, the procedure determines that the storage section 1-1-1-2 is the latest storage section.

Finally, in processing S105, the procedure reads out control data stored in the data storage segment 553 of the storage section 5S selected as the latest storage section, and copies the read-out control data to a mirror region of the RAM 4. For example, if the storage section 1-1-1-1 has been selected as the latest storage section, the procedure copies control data A stored in the data storage segment 1-1-1-1 to the mirror region 1.

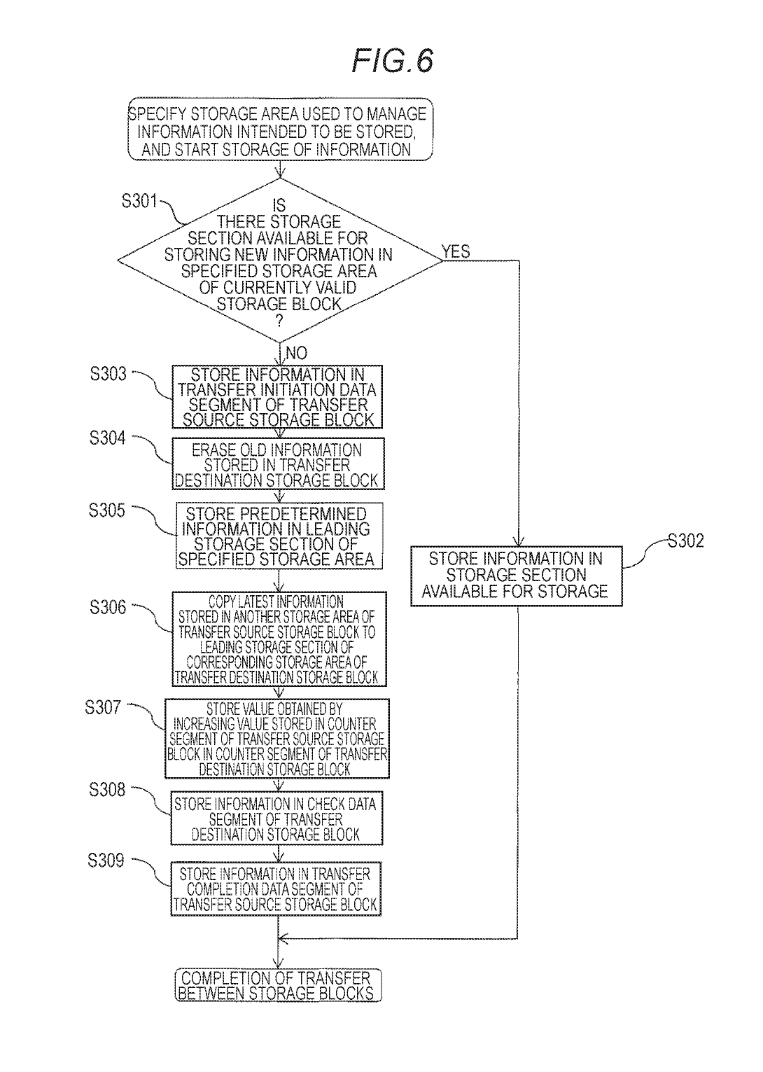

Next, a procedure for transferring data to a storage block in a case where a storage area in which to store new control data in the flash memory 5 has become insufficient is described in detail with reference to FIG. 2, FIG. 3, and FIG. 6. Storage in the flash memory 5 is performed for every piece of control data.

First, in processing S301 illustrated in FIG. 6, the procedure checks where in the information storage segment 55 of the storage block 5B the storage section 5S selected as being the latest at the time of selecting the latest control data is located. In a case where the latest storage section 5S is the trailing storage section in the storage area 5E of the latest storage block, the procedure determines that there is no storage section available for storing new control data in the latest storage block.

In a case where the latest storage section 5S is not the trailing storage section in the storage area 5E of the latest storage block, the procedure checks whether there is a storage section which has no information stored therein in the subsequent storage sections according to the alignment sequence of the flash memory, and, in a case where there is no storage section which has no information stored therein, the procedure determines that there is no storage section available for storing new control data in the latest storage block, and, in a case where there is a storage section which has no information stored therein, the procedure determines that there is a storage section available for storing new control data in the latest storage block.

For example, in a case where the information storage segment 55 has a configuration such as that illustrated in FIG. 3, if the latest storage section is the storage section 1-1-1-3, the procedure determines that there is no unused storage section. If the latest storage section is the storage section 1-1-1-1 and no information is stored in the storage section 1-1-1-2, the procedure specifies the storage section 1-1-1-2 as a storage section targeted for storage. If the latest storage section is the storage section 1-1-1-1, some information is stored in the storage section 1-1-1-2, and no information is stored in the storage section 1-1-1-3, the procedure specifies the storage section 1-1-1-3 as a storage section targeted for storage. If the latest storage section is the storage section 1-1-1-1 and some information is stored in the storage section 1-1-1-2 and the storage section 1-1-1-3, the procedure determines that there is no unused storage section.

In processing S301, when determining that there is a storage section which has no information stored therein, then in processing S302, the procedure writes predetermined pieces of information into the storage initiation data segment 551, the data storage segment 553, and the storage completion data segment 552 of the storage section 5S targeted for storage in this order. For example, in the case of storing control data A, if the storage section targeted for storage is the storage section 1-1-1-2, the procedure stores a valid value in the storage initiation data segment 1-1-1-2, stores the control data A in the data storage segment 1-1-1-2, and stores a valid value in the storage completion data segment 1-1-1-2, thus completing storage of control data.

The procedure sets a storage block next to the latest storage block in the storage group as a transfer destination storage block, and sets a storage block currently determined to be the latest as a transfer source storage block. In processing S301, when determining that there is no storage section which has no information stored therein, the procedure proceeds to processing S303 and subsequent processing, thus starting transfer of the latest storage block from the transfer source storage block to the transfer destination storage block. For example, in the case of a configuration such as that illustrated in FIG. 3, the procedure performs transfer of the latest storage block in the order of the storage blocks 1-1, 1-2, 1-3, and 1-1.

In transfer of the latest storage block, first, the procedure extracts a counter value from the counter segment 52 of the transfer source storage block, increases the counter value, and then retains the counter value.

After that, in processing S303, the procedure stores predetermined information in the transfer initiation data segment 53 of the transfer source storage block. Then, in processing S304, the procedure erases all of the pieces of old information stored in the transfer destination storage block.

Then, in processing S305, the procedure stores predetermined pieces of information in the leading storage section 5S of the storage area 5E used to manage specified control data in the transfer destination storage block in the order of the storage initiation data segment 551, the data storage segment 553, and the storage completion data segment 552. For example, in the case of issuing a storage instruction for control data A and transferring the latest storage block from the storage block 1-1 to the storage block 1-2, the procedure stores a valid value in the storage initiation data segment 1-1-1-1, the control data A in the data storage segment 1-1-1-1, and a valid value in the storage completion data segment 1-1-1-1 in this order.

Then, in processing S306, in a case where a plurality of storage areas 5E is arranged in the storage group 5G on which an operation is being performed, the procedure copies the latest data in a storage area used to manage control data for which a storage instruction is not issued, from the transfer source storage block to the transfer destination storage block. For example, in the case of issuing a storage instruction for control data A and transferring the latest storage block from the storage block 1-1 to the storage block 1-2, the procedure stores a valid value in the storage initiation data segment 1-1-2-1, control data B in the data storage segment 1-1-2-1, and a valid value in the storage completion data segment 1-1-2-1 in this order, and stores a valid value in the storage initiation data segment 1-1-3-1, control data C in the data storage segment 1-1-3-1, and a valid value in the storage completion data segment 1-1-3-1 in this order. In a case where only one storage area 5E is arranged in the storage group, the procedure omits processing S306.

After that, in processing S307, the procedure stores the counter value, which has been acquired from the counter segment 52 of the transfer source storage block, increased, and then retained, in the counter segment 52 of the transfer destination storage block. Then, in processing S308, the procedure stores a valid value in the check data segment 51 of the transfer destination storage block. Finally, in processing S309, the procedure stores a valid value in the transfer completion data segment 54 of the transfer source storage block, then completing storage of control data.

Furthermore, while, in the first embodiment, a case has been described in which a flash memory is used as a non-volatile memory, the invention is in no way limited to a flash memory, but can also be applied to a case where another type of non-volatile memory, such as EEPROM or magnetoresistive random access memory (MRAM), is used as a storage medium.

Moreover, while, in the first embodiment, a case has been described in which the invention is applied to an inverter control ECU arranged to implement rotational speed control of a vehicle-mounted rotating machine, which serves as an electronic control apparatus, the invention is not limited to this, but can be applied to general electronics in which data retention is required during the shutoff of power.

Furthermore, while, in the first embodiment, an example has been described in which the storage region of a flash memory is divided into three regions, i.e., the storage groups 1, 2, and 3, the number of storage groups can be changed to one or more depending on the situation of resources. Such a method as to divide information into groups depending on the frequency of update of the information to be stored, to arrange a small number of storage blocks in a storage group used to manage information having a low frequency of update, and to arrange a large number of storage blocks in a storage group used to manage information having a high frequency of update can be contrived, so that the regions of the non-volatile memory can be adjusted in such a manner that the frequency of update is not biased according to the regions.

Moreover, for example, even if important information, which causes a serious problem in the case of loss of data, is lost, another storage group is caused to manage recoverable information, so that such a situation that, when a storage group which is managing recoverable information has failed in transfer between storage blocks, even important information would be lost can be avoided.

Furthermore, while, in the first embodiment, an example has been described in which a storage group is divided into three regions, i.e., the storage blocks 1-1, 1-2, and 1-3, the number of divisions can be changed to one or more depending on the situation of resources. Since, in a case where a large number of storage blocks are arranged, the risk of loss of information decreases but the area occupied by a non-volatile memory increases, the number of arranged storage blocks can be adjusted with trade-off between the risk of loss and the occupied area.

Furthermore, while, in the first embodiment, an example has been described in which the storage area 1-1-1 arranged in the information storage segment 1-1 of the storage block is divided into three regions, i.e., the storage sections 1-1-1-1, 1-1-1-2, and 1-1-1-3, the number of divisions can be changed to one or more depending on the situation of resources. For example, in a case where a plurality of pieces of information managed by one storage group includes information having a high frequency of update and information having a low frequency of update, since, if a storage area which is managing information having a high frequency of update is set to have a large number of divisions of storage sections and a storage area which is managing information having a low frequency of update is set to have a small number of divisions of storage sections, regions having no information stored therein in the transfer source storage block during transfer between storage blocks can be reduced, the inside of the memory region can be used without any waste and, as a result, the frequency of update of the storage region can be reduced.

Furthermore, while, in the first embodiment, the latest storage section is specified by using a storage initiation data segment and a storage completion data segment arranged in a storage section, since data available for specifying the validity of information stored in a storage section and the order of update of a plurality of storage sections can be used without any problem, for example, a method of previously storing data about cyclic redundancy check and a counter, known in Patent Literature 2, and selecting the latest storage section can also be adopted.

Various modifications and alterations of the invention will be apparent to those skilled in the art without departing from the scope and spirit of the invention, and it should be understood that the invention is not limited to the illustrative embodiments set forth herein.

What is claimed is:

1. An electronic control apparatus comprising a non-volatile memory that is electrically erasable and a volatile memory,
wherein the non-volatile memory is provided with one or more storage groups in a storage region, each of the storage groups is provided with one or more storage blocks, each of the storage blocks includes an information storage segment, which stores control data to be used even after shutoff of power supply, a check data segment, which stores information indicating that the control data has been normally stored in the information storage segment, and a management information segment, which stores management information containing information used for determining whether the stored control data is old or new,
the information storage segment is provided with one or more storage areas, each of which is arranged to store control data to be stored in each of the storage blocks, each of the storage areas is provided therein with one or more storage sections each having a data storage segment,
each of the storage blocks is set as a unit of erasure with which data erasure is able to be performed by a single operation, and each of the storage sections is set as a unit of data writing.

2. The electronic control apparatus according to claim 1, wherein the management information segment of each of the storage blocks includes a transfer initiation data segment, which stores information indicating that, in transferring control data stored in a storage block to a storage block to be next used, transfer of the control data has been initiated, and a transfer completion data segment, which stores information indicating that storage of the control data in the storage block to be next used has been completed, and is configured to specify a storage block having the latest data stored therein based on pieces of information respectively stored in the transfer initiation data segment and the transfer completion data segment and by comparing the stored pieces of information in terms of which is old or new.

3. The electronic control apparatus according to claim 1, wherein the management information segment of each of the storage blocks includes a counter segment, which counts the number of times of transfer performed at each storage block, and is configured to, in a case where there is a plurality of valid storage blocks, by comparing counter values of the counter segments of the plurality of valid storage blocks, specify a storage block in which the counter value is largest as a storage block having the latest data stored therein.

4. The electronic control apparatus according to claim 1, wherein each of the storage sections includes a data storage segment, which is a region that stores optional data, a storage initiation data segment, which is a region that stores information indicating that storage of data in the data storage segment has been initiated, and a storage completion data segment, which is a region that stores information indicating that storage of data in the data storage segment has been completed.

5. An information storage method for an electronic control apparatus, the information storage method comprising providing one or more storage blocks, in each of which data erasure is able to be performed by a single operation, in a storage region of a non-volatile memory capable of electrically erasing data, providing one or more storage areas, each of which is capable of storing control data, in each of the storage blocks, providing a management information segment, to which a region for storing management information for determining whether control data stored in each of the storage areas is old or new is allocated, in each of the storage blocks, and, in a case where control data stored in the non-volatile memory is to be read out or in a case where a need has arisen to store new control data in the non-volatile memory, specifying a storage block in which new control data is stored by referring to the management information, which is stored in the management information segment and used for determining the old or new control data.

6. The information storage method for the electronic control apparatus, according to claim 5, wherein each of the storage blocks includes an information storage segment, which stores control data to be used even after shutoff of power supply, and a check data segment, which stores information indicating that the control data has been normally stored in the information storage segment, and the information storage method further comprises specifying, from among storage blocks selected as valid storage blocks as a result of validity verification for a storage block that is based on the information stored in the check data segment, a storage block in which new control data is stored by referring to the management information, which is stored in the management information segment and used for determining the old or new control data.

7. The information storage method for the electronic control apparatus, according to claim 6, wherein the management information segment of each of the storage blocks includes a transfer initiation data segment, which stores information indicating that, in transferring control data stored in a storage block to a storage block to be next used, transfer of the control data has been initiated, and a transfer completion data segment, which stores information indicating that storage of the control data in the storage block to be next used has been completed, and the information storage method further comprises specifying a storage block having the latest data stored therein based on pieces of information respectively stored in the transfer initiation data segment and the transfer completion data segment and by comparing the stored pieces of information in terms of which is old or new, and specifying the latest storage section from among storage sections of each storage area of the latest storage block.

8. The information storage method for the electronic control apparatus, according to claim 7, wherein the information storage method further comprises referring to pieces of information respectively stored in the check data segment, the transfer initiation data segment, and the transfer completion data segment of each of the storage blocks, and
in a case where there is only one storage block in which the information stored in the check data segment indicates the control data having been normally stored and the pieces of information stored in the transfer initiation data segment and the transfer completion data segment indicate an erased state, selecting the one storage block as a storage block having the latest control data stored therein.

9. The information storage method for the electronic control apparatus, according to claim 7, wherein the management information segment of each of the storage blocks further includes a counter segment, which counts the number of times of transfer performed at each storage block, and the information storage method further comprises causing, in performing transfer between the storage blocks, a value larger than a value stored in the counter segment of a storage block that is a source for transfer to be stored in the counter segment of a transfer destination storage block, referring to pieces of information respectively stored in the check data segment, the transfer initiation data segment, and the transfer completion data segment of each of the storage blocks,
in a case where a plurality of storage blocks in each of which the information stored in the check data segment indicates the control data having been normally stored and the pieces of information stored in the transfer initiation data segment and the transfer completion data segment indicate an erased state has been detected, comparing count values stored in the counter segments from among the detected plurality of storage blocks, and, in a case where there is only one storage block in which the count value is largest, selecting the one storage block as a storage block in which the latest control data among pieces of normally-stored control data is stored.

10. The information storage method for the electronic control apparatus, according to claim 7, wherein the information storage method further comprises referring to pieces of information respectively stored in the check data segment, the transfer initiation data segment, and the transfer completion data segment of each of the storage blocks,
in a case where there is no storage block in which the information stored in the check data segment indicates the control data having been normally stored and the pieces of information stored in the transfer initiation data segment and the transfer completion data segment indicate an erased state, referring to pieces of information respectively stored in the check data segment and the transfer completion data segment of each of the storage blocks, and
in a case where there is only one storage block in which the information stored in the check data segment indicates the control data having been normally stored and the information stored in the transfer completion data segment indicates an erased state, selecting the one storage block as a storage block in which the latest control data among pieces of normally-stored control data is stored.

11. The information storage method for the electronic control apparatus, according to claim 7, wherein the management information segment of each of the storage blocks further includes a counter segment, which counts the number of times of transfer performed at each storage block, and the information storage method further comprises causing, in performing transfer between the storage blocks, a value larger than a value stored in the counter segment of a storage block that is a source for transfer to be stored in the counter segment of a transfer destination storage block, referring to pieces of information respectively stored in the check data segment, the transfer initiation data segment, and the transfer completion data segment of each of the storage blocks,
in a case where there is no storage block in which the information stored in the check data segment indicates the control data having been normally stored and the pieces of information stored in the transfer initiation data segment and the transfer completion data segment indicate an erased state, referring to pieces of information respectively stored in the check data segment and the transfer completion data segment of each of the storage blocks,
in a case where a plurality of storage blocks in each of which the information stored in the check data segment indicates the control data having been normally stored and the information stored in the transfer completion data segment indicates an erased state has been detected, comparing count values stored in the counter segments from among the detected plurality of storage blocks, and, in a case where there is only one storage block in which the count value is largest, selecting the one storage block as a storage block in which the latest control data among pieces of normally-stored control data is stored.

12. The information storage method for the electronic control apparatus, according to claim 7, wherein the management information segment of each of the storage blocks further includes a counter segment, which counts the number of times of transfer performed at each storage block, and the information storage method further comprises causing, in performing transfer between the storage blocks, a value larger than a value stored in the counter segment of a storage block that is a source for transfer to be stored in the counter segment of a transfer destination storage block,
in a case where there is no storage block in which the information stored in the check data segment indicates the control data having been normally stored and the pieces of information stored in the transfer initiation data segment and the transfer completion data segment indicate an erased state and there is no storage block in which the information stored in the check data segment indicates the control data having been normally stored and the information stored in the transfer completion data segment indicates an erased state, referring to information stored in the check data segment of each of the storage blocks,
in a case where a plurality of storage blocks in each of which the information stored in the check data segment indicates the control data having been normally stored, comparing count values stored in the counter segments from among the detected plurality of storage blocks, and, in a case where there is only one storage block in which the count value is largest, selecting the one storage block as a storage block in which the latest control data among pieces of normally-stored control data is stored.

13. An information storage method for an electronic control apparatus, the information storage method comprising providing one or more storage blocks, in each of which data erasure is able to be performed by a single operation, in a storage region of a non-volatile memory capable of electrically erasing data, providing one or more storage areas, each of which is capable of storing control data, in each of the storage blocks, providing, in each of the storage blocks, an information storage segment, which stores control data to be used even after shutoff of power supply, a check data segment, which stores information indicating that the control data has been normally stored in the information storage segment, a transfer initiation data segment, which stores information indicating that transfer of control data has been initiated when control data stored in a storage block is to be transferred to a storage block to be next used, a transfer completion data segment, which stores information indicating that storage of control data in the storage block to be next used has been completed, and a counter segment, which counts the number of times of transfer between the storage blocks,
a step of, in a case where it is determined that a storage area in which to store new control data among the storage areas is insufficient in memory, storing predetermined information in the transfer initiation data segment of a transfer source storage block from among the storage blocks, a step of erasing control data stored in one storage block selected as a transfer destination storage block from among the storage blocks, a step of causing new control data to be stored in a storage area allocated to the transfer destination storage block, a step of causing a counter value acquired from the counter segment of the transfer source storage block, increased, and retained to be stored in the counter segment of the transfer destination storage block, a step of storing predetermined information in the check data segment of the transfer destination storage block, and a step of storing predetermined information in the transfer completion data segment of the transfer source storage block.

14. The electronic control apparatus according to claim 1, wherein the non-volatile memory is a flash memory.

15. The information storage method for the electronic control apparatus, according to claim 5, wherein the non-volatile memory is a flash memory.
